(19) United States
(12) Patent Application Publication
(10) Pub. No.: US 2007/0180836 A1
(43) Pub. Date: Aug. 9, 2007

(54) Closed-loop cycle cryogenic electronics cooling system with parallel multiple cooling temperatures

(76) Inventor: Leonid A. Shapiro, Upper Arlington, OH (US)

Correspondence Address: Leonid A. Shapiro, 1588 Longeaton Dr., Upper Arlington, OH, 43220-3875, US

(21) Appl. No.: 11/346,832

(22) Filed: Feb. 4, 2006

(51) Int. Cl. F25B 21/02; F17C 5/02; F25D 23/12

(52) U.S. Cl. 62/3.2; 62/259.2; 62/47.1

(57) ABSTRACT

An closed single-loop low-energy/energy-independent cryocooler that removes high quantities of heat from a large area while utilizing a design that allows multiple temperatures on multiple cooled areas in parallel to allow for use on complex electronics which have different preferred operating temperatures. An energy independent design is a simple TEG based variation of the standard invention design. Said system allows for different uses such as for the cooling of over-clocked computer systems working at high heat loads, superconducting circuits, and/or the efficient cooling of temperature dependent devices such as laser diodes and etc. The said cooling system comprises of a hydraulic or pneumatic driven cylindrical single piston gas compressor, several multi-stage thin-film thermoelectric coolers (TEC), several thin-film single-stage high temperature thermoelectric generators (TEG), an enclosure with hollow passages inside the walls or attached loops of coiled copper tubes, a multi-way heat exchanger, and a evaporator.

### FIELD OF THE INVENTION

The present invention relates to high-capacity both sub-cryogenic and above-cryogenic cooling. The primary area of importance is the inventions utilization for the cooling of electronics. More specifically, it is suitable but not limited to the cooling of computer systems for the purposes of allowing operation under over-clocked and/or super-conducting conditions of the microprocessor components by using liquid refrigerants in the phase change state.

### BACKGROUND OF THE INVENTION

The problem of cooling electronics in tight spaces is an old problem but one that is in rising importance as the average temperature for a silicon based chip increases with the number of transistors. In the past, small heatsinks or other passive cooling would be installed. While this was sufficient for low wattage units, a larger wattage would render these heatsinks to overheat. The way to counter this was to install larger heatsink. But due to size limits, anything overly large was a problem.

There are other forms of cooling such as fan cooling and water cooling which have a wide range of applications but both need space and both provide just enough headroom for operation of the electronic device but no more then that. Usually these either complement a heatsink or have a radiator which is a heatsink in the water loop. Also, water cooling only reaches extremely high capacity when boiling which is suitable for generators or other high temperature high heat load devices but very harmful for a most microprocessors or silicon circuits. Nevertheless, these forms of cooling are the most widely used due to their low price and simplicity.

Another popular alternative solution was to install a thermoelectric cooler (TEC) to the top of the electronics. A TEC can also be soldered or brazed into the circuit if the device is small enough. An aluminum heatsink with copper core would then be mounted onto the TEC hot side to keep that from overheating. Again, if the heat produced was too much, then an even larger TEC would be needed and the hot size would increase in the heat it produces making the heatsink cooling the hot side overheat very quickly. This has escalated to the point that in desktop computers for instance, a large water cooling loop or even a chiller would be needed to cool the hot side. What is even more harmful is that the TEC hot side temperature increases when the cold side temperature decreases, or when the size of the TEC is expanded. That brings with it the problem of now cooling the TEC itself with active cooling to prevent failure of the TEC in order to prevent failure of the device cooled by the TEC.

Concerning the computers of today and of the close future, to cool today's average personal computer, which generates on average 100-200 Watts of heat, would need a TEC ranging with power requirements of 120-360 Watts. This is actually more power then the CPU would itself require at full load or even increased voltage. In a mobile device for example, without a direct electrical cord to plug into a socket, this is very hard to implement, let alone to find a way to cool such a TEC. A thin film TEC may be better then a conventional TEC but it is not efficient enough for the cooling of computers.

Of the above, only the TEC method, as shown in U.S. Pat. No. # 6,662,570 granted to Mr. Venkatasubramanian, may reach cryogenic temperatures which are in theory the best work environment for electronics and one that allows for overclocking. Overclocking is a method in modern microprocessors which, if supported by the BIOS, usually in computers and game consoles, allows more current to go to the microprocessor and allows the microprocessor to be forced to function at a higher frequency of signals received and sent per second for standard semiconductor based microprocessors.

There are other forms of cooling to cryogenic temperatures. These methods are mainly industrial cooling methods which use the phenomenon of phase change in liquid Helium, liquid Nitrogen, etc. Those methods are purely industrial or for laboratory use because they require a 3-stage power connection and use multiple kilowatts at that, and often require other cooling devices to cool them. Many times, these are based on the Stirling Cycle Cryocooler. Not only that, but they sometimes require a vacuum around the object cooled to effectively function. Quite often, models have their heat removal capacity limited to below 200 Watts and most like around 20-50 Watts unless a full scale multistage system is used.

For example, the U.S. Pat. No. 5,647,217 granted to L. B. Penswick and R. E. Neely gives the general design of the Stirling Cycle Cryogenic Cooler. That consists of a compressor piston inside a cylinder and an expansion piston within a cylinder and a driving mechanism such as a motor. This then functions as a reciprocating motion compressor which can be expanded as shown then the stated patent into a cryocooler if a gas is constantly fed by a pump.

There is of course the older Joule-Thomson cryostat which has a “Joule-Thompson Valve,” but again you need a constant supply of high pressure gas and you need a large amount of the gas to use effectively because such a device is often open loop. Thus, that requires a pump, a large reciprocating gas compressor, a heat exchanger to cool the compressor, a multi-hundred gallon (if not more) pressurized gas tank, and still the 3-stage power requirement which is only available in industrial zone. The main problem is that gas is compressed often as much as a thousand times in volume when compared to a liquid variant. Because the idea of rapid expansion uses pressures higher then that required to liquefy, a incredibly huge amount of gas is required to be fed in order to be of any practical use.

A more exotic cooling solution is using lasers to slow down single atoms to temperatures very near absolute zero thus resulting into a Bose-Einstein Condensate (BEC). This is the coldest object in the Universe that can exist but is only the size of a few atoms and must be kept in a magnetic field and in a vacuum to make this. This is only possible in laboratories and under certain machinery and conditions not to mention the cost of millions of dollars for the equipment need. The BEC also is too small to cool an object with a mass slightly greater then itself. Thus, this cannot be used in any application where more extreme cooling is needed other then to be used in experiments. This is not in any way practical in any environment.

The most powerful form of cooling is surprisingly evaporative (phase change) cooling because laser cooling can only work to within a degree of absolute zero but evaporative cooling which is phase change cooling can go even below that while cooling a respectively much larger quantity of molecules. In temperatures of around 30-130K were it excels in heat capacity and temperature compared to other forms of cooling such as rapid expansion or thermoelectric heat removal. The gas is compressed and cooled to its critical temperature and pressure and the liquid gas is poured on a surface were it boils and removes great amounts of heat quite quickly. But these systems such as the Stirling cycle liquefier are load, large, and multistage requiring several phase change systems cooling one another in order to allow the final phase change system to achieve the lowest possible temperature. This is where the invention presented here fits in.

### SUMMARY OF THE INVENTION

The object of this invention is a compact closed loop single stage sub-cryogenic cooler with a high heat removal capacity that may provide different cooling temperatures on several parts of the cooled surface of an electronics system at the same time. The cooler has to function with any gaseous refrigerant while having only modest or insignificant power requirements, and to provide cooling which does not create condensation on or deteriorate the electronic cooled in any way. The invention presented accomplishes all these objects by the use of a special heat exchanger setup, incorporation of the cooler into the electronics or computer system casing, and by the use of both phase change evaporative cooling and thermoelectric heat pumping. The use of a thin-film thermoelectric generator (TEG) to change heat given off by the electronic into electricity by the use of thin film thermoelectric generators also allows the invention to function independent of any power requirements.

### DESCRIPTION OF DRAWINGS

FIG. 1 is a general diagram of the closed-cycle design. The closed container which holds the objects being cooled is shown open to allow view of cooling coils and evaporator. Though cooling coils are shown, the preferred solution uses hollowed out walls instead. Either may be used to achieve the same result.

FIG. 2 is an example design based on FIG. 1, that is meant to provide cooling of densely packed electronics in small confined areas while being independent form any outside power source.

FIG. 3 is a side cut view of the evaporator detailed in FIG. 1 composed of eight parts with brazed fillets indicated.

### DETAILED DESCRIPTION AND PREFERRED EMBODIMENTS OF THE INVENTION

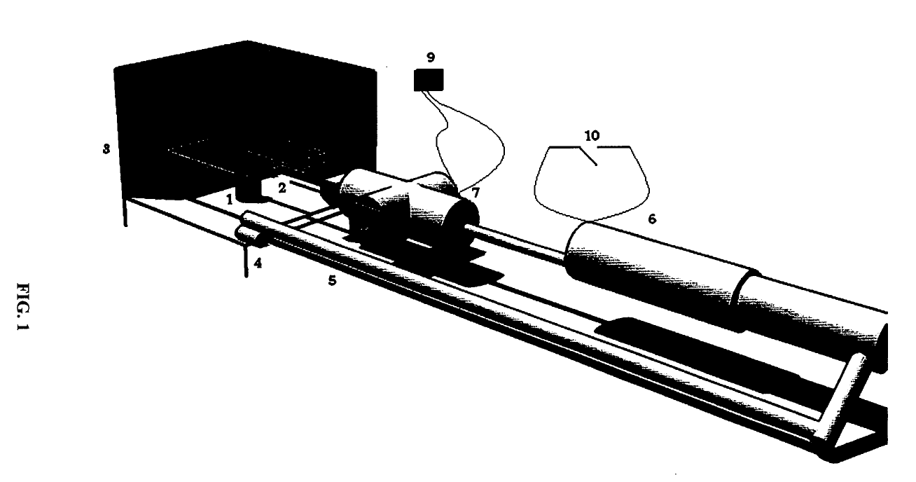

The invention detailed according to FIG. 1 is composed of ten distinct parts. The electronics system being used with the cooling system is placed inside an insulated airtight chamber 3. The microprocessor or other main electrical component is cooled with evaporator 1 placed onto the component using a thin film low melting point solder which is placed in between the evaporator and component. After the first use, the evaporator would be solidly soldered to the electronic component by the heat generated from the electronic component itself, and thus provide the best heat transfer possible. A liquid refrigerant inside the evaporator evaporates and removes enough heat to create cryogenic temperatures if a refrigerant with a cryogenic boiling point is used. The gas exiting from the evaporator 1 would purge the inside of the chamber 3 and create an environment without condensation. The air or other contaminant inside would be pushed out of a one way pressure valve 4 at system start-up. This provides a totally safe environment for the electrical components and allows the operation under low temperatures without condensation. More evaporators may be used if more then one dense electrical components are present.

As the still relatively sub ambient gas from the evaporator 1 fills the chamber 3, it is eventually pushed out of the chamber 3 into a tube 5 which leads it to a compressor in the form of a piston 6. The piston compressor is operated by an electrical hydraulic or pneumatic pump pushing a gas or liquid (not shown in FIG. 1). The piston 6 is pushed by the hydraulics/pneumatics and compressed the gas to the critical pressure of the gas used which is regulated by a simple resistor based circuit 10.

The gas is now at an even higher temperature due to being compressed and is now sent to a multi-way heat exchanger 7 which in order to provide a stable design under high pressures of as much as 50 Bar and above. The heat exchanger 6 is composed of at least, a three way cylindrical structure with any extra passages other then the input and output to be capped with a flat end. A preferred four way structure 7 is shown. Onto each cap, a thin film multi-stage TEC 8 unit is brazed. The output passage is closed off with a temperature controlled valve built into the heat exchanger 7. The TEC(s) cool the compressed gas to its critical temperature and the gas after a short time period in the heat exchanger 7 changes state from gas to liquid and is sent to be used for cooling. The chamber 3 is used as a heat sink for the TECs 8 to remove the total heat from their hot sides. This is not shown in FIG. 1 for sake of clarity of diagram. The greater the cooling capacity and delta T of the TEC(s) 8 the shorter the time period the gas is kept in the heat exchanger 7. The greater the number of TECs 8 the shorter the time period the gas is kept in the heat exchanger 7.

The more TECs 8, the more ways the heat exchanger 7 must branch off and the more ways the heat exchanger is branched of, the faster the gas is liquefied. But, power considerations must be taken into account because a high temperature TEG 10 may be used to power the hydraulic/pneumatic pump (not shown) and the TECs 8. The TEG(s) 10 will be placed onto the electronic system in a place were heat is generated and onto the piston compressor 6 and the chamber 3 to salvage some extra electricity. The power generated is a small percentage of the heat present on both the heat generating electronic and heat of the compressed gas (which is heat from main electrical component(s)+heat from compression.) On certain configurations, it is possible to have enough electricity generated to allow the whole system to function from that. This is mainly possible when high temperature electronics such as dense silicon microprocessor chips or power supply capacitors are part of what is being cooled.

The liquid refrigerant is sent to either hollow sections of the chamber 3 walls or a more economical approach is used and the refrigerant is sent to coils 2 instead. The coils 2 go around the inside of the chamber and control the ambient temperature inside the chamber. From the coils 2, the refrigerant goes to the evaporator. When the evaporator 1 is full, no more refrigerant is compressed and that what was in the coils 2 evaporates and goes to the evaporator 1. The temperature of the evaporator 1 is always around that of boiling point of the refrigerant unless a severe pressure change is forced by the piston compressor 6. But, the problem with many electronics in parts such as capacitors may not function well at that low of a temperature but must not go above a certain other temperature. Refrigerant is sent in bursts from the heat exchanger 7 and it evaporates in shorter time span thus removing less heat and keeping the ambient temperature at higher or lower as required. If the coils 2 are filled all the time, then the temperature of all electrical components will also be like that in the evaporator 1. Finally, if there are more main electrical components such that more evaporators 1 are required, then they can be situated at intervals on the coils 2 and their temperature may be controlled by number of bursts of refrigerant over a time period or simply constant flow for the lowest possible temperature attainable with that refrigerant. This temperature control applies to all cooling parts: coils 2, and evaporator(s) 1. If a even lower temperature than the boiling point of the refrigerant used is required then the voltage fed to the TECs 8 is raised and the piston 6 pumps more gaseous refrigerant into the same volume to a point that the pressure goes higher than the critical pressure.

The cycle of heating, evaporation, compression, and cooling of compressed gas is repeated through the system for as long as the electronics cooled are in use.

### EXAMPLE 1

The electronics system tested was a computer system composed of a stock 3.6 GHz Pentium 4 (90 nm variant) CPU plugged into an ASUS P5WD2 Premium motherboard with Nvidia based XFX produced 7800 GTX video card and Corsair 5400UL 667 MHz DDR2 RAM powered by a 658 Watt Athena Power Supply. This computer system ran using the cooling system and allowed the system to work at 170% stock speed while having the RAM run at 1.2 GHz, which is close to 200% stock speed. The cooling system provided much more room for a greater temperature increase of the system. After a certain front side bus speed, the system stopped responding leading to the conclusion that some of today's highest frequency systems, operating with this invention, actually run into hardware problems of the system before they run into cooling problems. This is unlike whereas without this invention, a computer system would overheat with a heat spike after running at increased voltage and/or frequency much earlier before it reaches its limit to increase the frequency.

### EXAMPLE 2

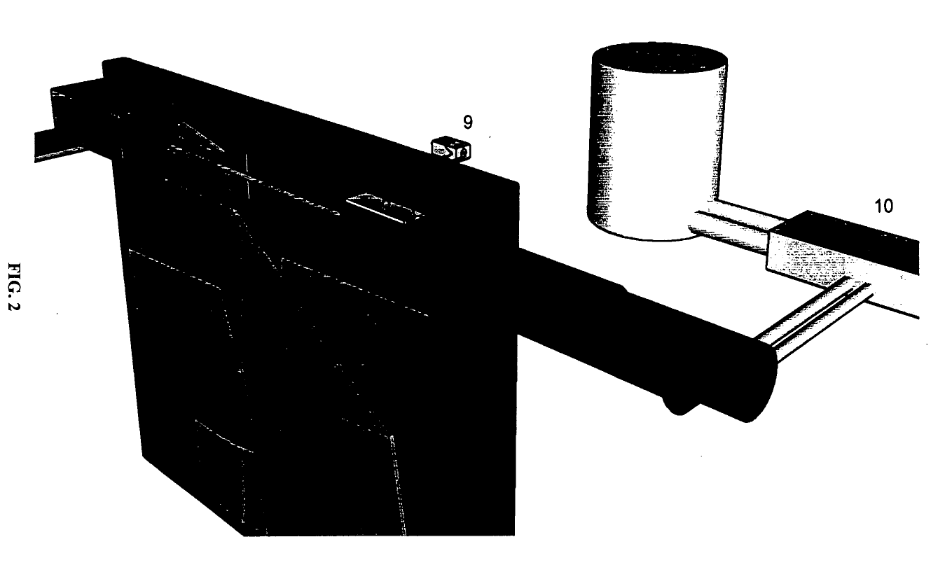

FIG. 2 details a design of a solution based on this invention, to cool one or more 50 W electronic chips in a closed compact environment. The system designed is a modular system that utilizes the TEG as the major power source and had modular graphite filled double sided 5 mm heat sinks attached to the bottom of the evaporator in order to cool densely packed silicon chips. The fact that the compressor used was a small cylindrical piston with a equally sized electrical pump instead of the typical oil based gas compressor used in this type of setup, allows for stern space requirement in mobile applications such as laptops or other electronic equipment to be met, while still allowing used of a reliable closed loop solution

### EXAMPLE 3

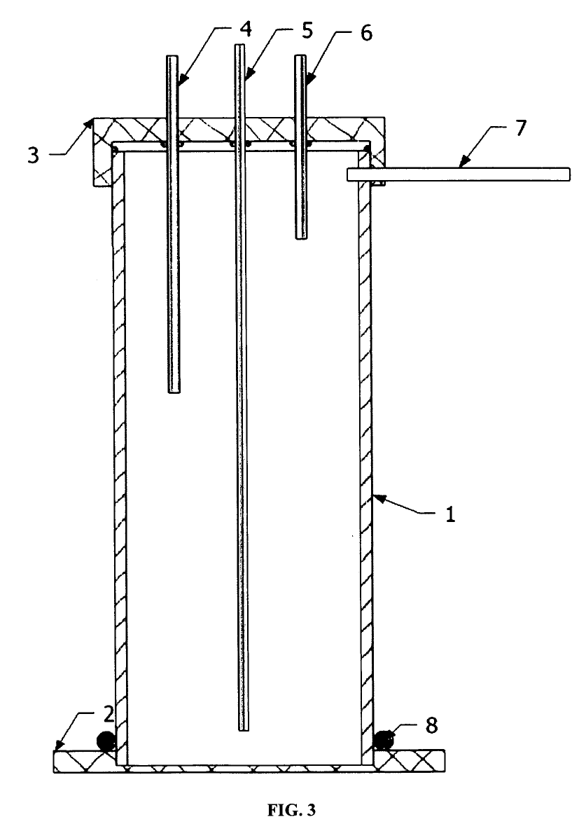

FIG. 3 is the design of the evaporator referred to use in Example 1. This evaporator is composed of copper alloy. This evaporator consists of eight standard parts: a cylindrical body 1 to hold a refrigerant under pressure, a composite cold plate 2, a copper alloy cap 3, a refrigerant input tube 5, two separate vapor outputs 6, 7, a thermocouple holding tube 4, and several brazing metal joints 8 which hold the design together.

What is claimed is:

1. The closed-loop cycle cryogenic electronics cooling system with parallel multiple cooling temperatures comprising of:
an electronic system that includes one or more microprocessors and/or other cooled materials/surfaces/components that may be used in sub-ambient temperature environments,
a cryogenic cooling system providing simultaneous cooling of microprocessor and computer components down to different temperatures down to 2 K by supplying liquid refrigerant to said microprocessors and/or material, and whereby the said cryogenic system is composed of a single closed-loop unit.

2. The closed-loop cycle cryogenic cooling system with parallel multiple cooling temperatures according to claim 1, wherein the cryogenic cooling system comprises of:
a cooled surface on the microprocessor/electronic,
an evaporator which is placed onto the microprocessor to disperse heat from the said microprocessor by said evaporator having a minimum of one inlet and one outlet,
an insulated enclosure into which the computer system and evaporator are placed inside and said enclosure having multiple walls (layers) with the hollow area between the two innermost walls, and the other layers to be filled with thermal insulation or simple a single walled enclosure with brazed hollow coils around the inside walls,
a refrigerant to be pumped through the hollow area between the walls in liquid or gaseous states of matter,
a single piston compressor powered by a hydraulic or pneumatic pump,
a connection with the hollow wall or coils,
a pressure controlled valve,
a thin film high temperature thermoelectric generator(s),
a voltage limiting control circuit,
a one way valve going into the piston for purposes of introducing/removing the said refrigerants, and
a multi-way heat exchanger with attached thermoelectric units and connections to the thin-film thermoelectric generators unit.

3. The closed-loop cycle cryogenic computer system with parallel multiple cooling temperatures according to claims 1 and 2, wherein the refrigerant used in the cryogenic cooling system is Nitrogen, or Helium, or other low boiling point substance.

4. The multi-way heat exchanger according to claim 2 comprises of:
a minimum of three way pipe with circular flat cap brazed to all but two of the openings,
a minimum of one multistage thin-film thermoelectric cooler brazed/soldered to circular flat cap(s),
a heatsink, and
a set of electric contacts.

5. The evaporator according to claim 2 comprises of:
a brazed hollow metal, ceramic, graphite or composite material body, an outlet tube,
an inlet tube,
a tube for thermal sensor,
a composite material cold plate, and
a thin layer of brazing or soldering paste with ground diamond, graphite, or other good heat transfer material that melts at low temperatures.
